(19) United States
(12) Patent Application Publication
(10) Pub. No.: US 2014/0000516 A1
(43) Pub. Date: Jan. 2, 2014

(54) DIGITAL POINT MARKING TRANSFER

(71) Applicant: Brian Ray Dickinson, Grass Lake, MI (US)

(72) Inventor: Brian Ray Dickinson, Grass Lake, MI (US)

(73) Assignee: Toyota Motor Engineering & Manufacturing North America, Inc., Erlanger, KY (US)

(21) Appl. No.: 13/537,245

(22) Filed: Jun. 29, 2012

(51) Int. Cl. G06K 9/62; B05D 5/00; B26D 3/00; B05C 9/00

(52) U.S. Cl. 118/712; 427/256; 83/861; 382/103

(57) ABSTRACT

A contrast target tool for locating and marking a desired location on a surface of an object. The contrast tool can have a target flange with a plurality of contrast targets thereon and a marker that is rigidly attached to and extending from the target flange. The marker can have a marker end that is operable to produce a mark on the three-dimensional object and the target flange with the marker can be operable to be viewed by a digital imaging system. In this manner, a present location of the marker end can be determined and tracked in real time to allow the operator to locate and place the marker end at the desired or precise location on the object surface and produce a mark thereon.

### FIELD OF THE INVENTION

The present invention is related to a contrast target tool and, in particular, a contrast target tool having a marker end that can be tracked by a digital imaging system and used to place a visible mark on a surface at a desired location.

### BACKGROUND OF THE INVENTION

An important activity in industrial manufacturing and/or repair can include finding a precise location on a surface of a part or component in order to attach a separate component at a desired location or to remove a portion of the surface at the desired location. For example, a three-dimensional object such as an automotive panel can be modified by placing or cutting a hole, slot, and the like at a desired location within the panel. However, finding a precise location on a three-dimensional contoured surface can be timely and require placement of the object within a machining fixture, measurement block, etc. As such, a tool and/or a process for finding a precise location on such a surface that reduces time and effort would be desirable.

### SUMMARY OF THE INVENTION

A contrast target tool for locating and marking desired location on a surface of a two-dimensional or three-dimensional object is provided. The contrast target tool can have target flange with a plurality of contrast targets thereon and a marker that is rigidly attached to and extending from the target flange. The marker can have a marker end that is operable to produce a mark on the surface of the three-dimensional object and the target flange with the marker can be viewed and tracked by a digital imaging system. In addition, a present location of the marker end can be determined, tracked and provided to a user in real time, thereby aiding the user in locating and placing the marker end at the desired location on the object surface in a time efficient manner. The marker can be a center punch that is operable to put an indentation on the surface of the object, a retractable marker pen operable to put an ink mark on the surface of the object, and the like. In addition, the marker can be operable to produce the mark on the surface of the object when a force is applied thereto.

A process for locating and marking a desired location on a surface of an object is also provided, the process including providing the object with the surface that has the desired location thereon. In addition, the process includes providing a contrast target tool having a target flange with a plurality of contrast targets, in addition to a marker that is rigidly attached to and extending from the target flange. The marker can have a marker end that is operable to produce a mark on the surface of the object.

A digital imaging system with a camera and a display screen is also provided, the digital imaging system operable to recognize the plurality of contrast targets on the target flange and determine a location in real time of the marker end. The contrast tool is held proximate to the surface of the object and real time digital coordinates of the marker end are displayed on the display screen. In addition, the marker end is moved along the surface of the object while the real time digital coordinates are viewed on the display screen until the marker end is positioned at the desired location. Thereafter, the surface of the object is marked at the desired location with the marker end of the marker.

### BRIEF DESCRIPTION OF THE DRAWINGS

FIG. 1 is a perspective view of an embodiment of the present invention located proximate to a surface to be marked at a desired location; and

FIG. 2 is a perspective view of the embodiment shown in FIG. 1 illustrating a digital imaging system with a display screen.

### DETAILED DESCRIPTION OF THE PRESENT INVENTION

A contrast tool for locating and marking a desired location on a surface of a three-dimensional object is provided. As such, the contrast target tool has use as a manufacturing tool.

The contrast target tool can include a target flange that can be generally planar in nature and have a plurality of contrast targets thereon. In addition, a marker can be rigidly attached to and extend from the target flange. The marker can have a marker end that is operable to place or create a mark on a surface of a three-dimensional object when desired.

The target flange with the plurality of contrast gets can be viewed by a digital imaging system to provide a precise location of the target flange, the marker and/or the marker end in real time. For the purposes of the present invention, the term “real time” refers to determining and/or providing the precise location of the target flange, contrast targets, marker and/or marker end within strict time constraints and/or without perceivable delay. For example, “real time” can be determination and/or providing of the location of the marker end and providing coordinates of the end within 1 second, 0.5 seconds, 0.1 seconds, 0.01 seconds, 0.001 seconds 0.0001 seconds, 0.00001 seconds or 0.000001 seconds. In this manner, the marker end can be tracked as it is moves across a surface of a three-dimensional object until a desired location is found on the surface of the object. In addition, upon placement of the marker end at the desired location, the marker can place a visible mark on the surface such as a center punch indentation, an ink mark, and the like.

In one embodiment, an individual can hold the contrast target tool in their hand and the contrast targets can be in line of sight of a camera that is part of an imaging system. In some instances the imaging system can be a three-dimensional digital imaging system as is known to those skilled in the art. In addition, a display screen can be provided and be viewable by the individual with the imaging system providing a position of the marker end on the display screen in real time as the individual moves the contrast target tool. The imaging system can also have data, e.g. CAD data, of a desired location on an object and/or a surface of an object, and the individual can track the location of the marker end as it approaches the desired location on the object surface. Once the marker end has been placed at the desired location on the surface of the object by the individual, a force can be applied onto the marker which affords for a mark to be placed on the surface.

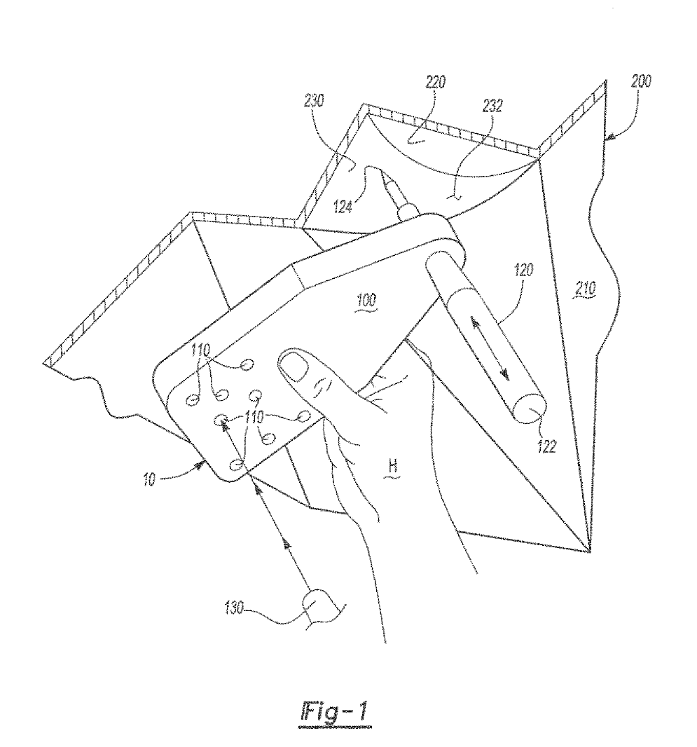

Turning now to FIG. 1, a contrast target tool is shown generally at reference numeral 10. The contrast target tool 10 can have a target flange 100 with a plurality of contrast targets 110 located thereon. The contrast target tool 10 can also have a marker 120 that has a distal end 122 and a marker end 124. In some instances, the marker 120 can be an automatic center punch that upon providing a force on the distal end 122 results in a center punch indentation to be created on a surface by the marker end 124 as is known to those skilled in the art. Also shown in FIG. 1 is a camera 130 that has a line of sight to the plurality of contrast targets 110. In some instances, the camera 130 can be a digital camera.

Proximate to the contrast target toll 10 can be an object 200 having a surface with a desired location, point, position, etc., thereon. The object 200 also illustratively has a first surface 210, a second surface 220, and a third surface 230. The third surface 230 can be arcuate, that is contoured, and have a desired location 232 thereon. The desired location 232 can be a location0 where an aperture is desired and as such the contrast target tool 10 can provide a mark at the location 232 as disclosed herein.

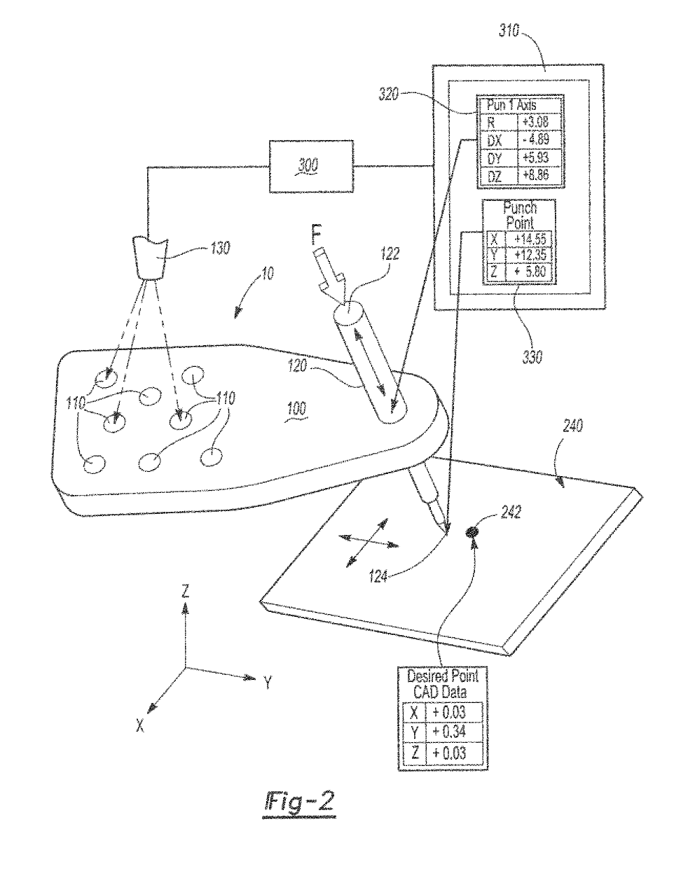

Referring now to FIG. 2, the contrast target tool 10 can be placed proximate to surface 240 which has a desired location 242. The desired location 242 can be provided to an operator and/or to a digital imaging system 300 that includes the digital camera 130 and a display screen 310. In addition, the digital imaging system 300 can have a real time location of an axis of the marker 120 (see Pun 1 Axis) and a real time location of the marker end 124 (see Punch Point) as shown at 320 and 330, respectively. Given that the desired point 242 is known by the digital imaging system 300 and/or an operator, e.g. via CAD data, the contrast target tool 10 can be moved until the marker end 124 is located at the desired location 242.

It is appreciated that the display screen 310 can provide the real time location of the marker end 124 such that an operator can track the position of the marker end 124 as it approaches the desired location 242 on the surface 240. Upon reaching the desired location 242, a force F can be placed upon the distal end 122 and afford for a mark to be placed at the desired location 242 on the surface 240. As stated above, the marker 120 can be a center punch such that the force F provides an indentation at the desired location 242 on the surface 240 or, for example, the marker 120 can be a marking pen that provides an ink mark at the location 242.

In some instances, the digital imaging system 300 can determine a location, orientation, etc., of the three-dimensional object 200 and/or surface 240 such that the object 200 and/or surface 240 do not have to be precisely placed within a machining fixture, measuring block, and the like. For example, the digital imaging system 300 can determine the location, orientation, etc., of the object using photogrammetry, laser scanning, etc., as known to those skilled in the art. In addition, once the location, orientation, etc., is known to the digital imaging system 300, it is appreciated that the desired location 232 and/or 242 can be determined and/or is known by the system 300 such that in combination with real time tracking of the marker end 124, an operator can determine when the marker end 124 is located at the desired location 232 and/or 242.

A process for locating and marking a desired location on a surface of the object can include providing an object having a surface and providing the contrast tool 10. In addition, the digital imaging system 300 with the camera 130 and display screen 310 can be provided with the system 300 affording for recognition of the surface as well as the plurality of contrast targets 110 on the target flange 100. The contrast target tool 10 is held proximate to the surface of the object, e.g. by an individual, and the digital imaging system 300 displays in real time digital coordinates of the marker end 124 on the display screen 310 as illustrated at reference numeral 330. The display screen 310 can also display the coordinate(s) of the desired location, point, etc., to be marked and the marker end 124 can be moved along the surface 230 and/or 240 while the real time coordinates of the marker end are viewed on the display screen. The marker end can then be positioned at the desired location 232 and/or 242 on the surface of the object and the surface marked with the marker end 124. In this manner, a cost- and time-efficient process for locating and marking a desired location on a surface of an object is provided by the contrast target tool disclosed herein.

The contrast target tool and the process described above are appreciated to be exemplary embodiments of the invention but do not limit the scope thereof. In addition, the target flange can be made from any material known to those skilled in the art, illustratively including metals, alloys, plastics, ceramics, and the like. The marker can be any marker that can be rigidly attached to the target flange, illustratively including a center punch, an automatic center punch, a retractable marker pen, a non-retractable marker pen, and the like. The digital imaging system be any imaging system known to those skilled in the art, illustratively including systems provided by GOM mbH, AICON 3d Systems, Breuckmann GmbH and Steinbichler Optotechnik. As such, the specification should be interpreted broadly and it is the claims and all equiv is which define the scope of the invention.

I claim:

1. A contrast target tool for locating and marking a desired location on a three-dimensional object, said contrast target tool comprising;
a target flange having a plurality of contrast targets thereon; and
a marker rigidly attached to and extending from said target flange, said marker having a marker end operable to produce a mark on the three-dimensional object;
said target flange with said marker operable to be viewed by a digital imaging system such that a present location of said marker end is determined, tracked in real time and provided to an operator in order to allow the operator to locate and place said marker end at the desired location on the three-dimensional object and produce a mark thereon.

2. The contrast target tool of claim 1, wherein said marker is a center punch operable to put an indentation on the three-dimensional object.

3. The contrast target tool of claim 1, wherein said marker is a retractable marker pen operable to put an ink mark on the three-dimensional object.

4. The contrast target tool of claim 1, wherein said marker is operable to produce said mark on the three-dimensional object when a force is applied to said marker.

5. The contrast target tool of claim 4, wherein said marker is a center punch and the force is a push force onto said center punch.

6. The contrast target tool of claim 1, further comprising a display screen operable to display and provide viewing in real time digital coordinates of the present location of said marker.

7. A contrast target tool system for locating and producing a mark at a desired location on an object, said system comprising:
a target flange having a plurality of contrast targets thereon;
a marker rigidly attached to and extending from said target flange, said marker having a marking end operable to produce a mark on the object when the desired location on the object is determined; and
a digital imaging system with a camera and display screen, said digital imaging system operable to recognize said plurality of contrast targets on said target flange and determine a digital location in space and real time of said marking end, said digital imaging system also operable to display digital coordinates of said digital location in real time on said digital screen and allow an operator to track said digital location and find the desired location on the object, apply a force to said marker and produce the mark on the object at the desired location.

8. The contrast target tool system of claim 7, wherein said marker is a center punch operable to put an indentation on the object.

9. The contrast target toot system of claim 7, wherein said marker is a retractable marker pen operable to put an ink mark on the object.

10. The contrast target tool of claim 7, wherein said marker is operable to produce said mark on three-dimensional object when a force is applied to said marker.

11. The contrast target tool of claim 10, wherein said marker is a center punch and the force is a push force onto said center punch.

12. A process for locating and marking a desired location on a surface of an object, the process comprising:
providing an object having a surface with a desired location thereon;
providing a contrast target tool having a target flange and a plurality of contrast targets on the target flange, the contrast target tool also having a marker rigidly attached to and extending from the target flange, the marker having a marker end operable to produce a mark on the surface of the object;
providing a digital imaging system with a camera and a display screen, the digital imaging system operable to recognize the plurality of contrast targets on the target flange, the digital imaging system also operable to determine a location in real time of the marker end;
holding the contrast target tool proximate the surface of the object;
displaying real time digital coordinates of the marker end on the display screen;
moving the marker end along the surface of the object while viewing the real time digital coordinates of the marker end on the display screen until the marker end is positioned at the desired location on the surface of the object; and
marking the surface of the object at the desired location with the marker end of the marker.

13. The process of claim 12, wherein the marker is a center punch and the marking is an indentation on the surface of the object.

14. The process of claim 12, wherein the marker is a retractable marker pen and the marking is an ink mark on the surface of the object.

15. The process of claim 12, wherein marking the surface of the object at the desired location with the marker end of the marker includes applying a force onto the marker.

16. The process of claim 15, wherein the marker is a center punch and the force applied to the marker is a push force that results in the center punch creating a punch mark on the surface of the object.

17. The process of claim 15, wherein the marker is a retractable marker pen and the force applied to the marker is a push force that results in the retractable marker pen creating an ink mark on the surface of the object.
